(19) United States
(12) Patent Application Publication
(10) Pub. No.: US 2025/0106602 A1
(43) Pub. Date: Mar. 27, 2025

(54) TELEMETRY SYSTEM INCLUDING A SENSOR STATION ARRAY AND AN AERIAL DATA COLLECTION SYSTEM

(71) Applicant: Microchip Technology Incorporated, Chandler, AZ (US)

(72) Inventor: James Russell, Plymouth, MN (US)

(73) Assignee: Microchip Technology Incorporated, Chandler, AZ (US)

(21) Appl. No.: 18/400,911

(22) Filed: Dec. 29, 2023

Related U.S. Application Data
(60) Provisional application No. 63/540,684, filed on Sep. 27, 2023.

(51) Int. Cl. H04W 4/38; B64C 39/02

(52) U.S. Cl. CPC H04W 4/38; B64C 39/024

(57) ABSTRACT

A telemetry system includes an array of sensor stations arranged in a spaced apart arrangement, wherein respective sensor stations include a respective sensor to generate respective sensor data regarding a respective sensed parameter, a respective sensor station memory to store the respective sensor data, a respective sensor station antenna, a respective sensor station wireless transmitter, and a respective sensor station processor to periodically activate the respective sensor station wireless transmitter to transmit the respective sensor data via the respective sensor station antenna. The telemetry system includes an aerial data collection system including an aerial data collection system antenna, and an aerial data collection system receiver to receive the respective sensor data transmitted by the respective sensor station antenna.

### RELATED APPLICATION

This application claims priority to commonly owned U.S. Provisional Patent Application No. 63/540,684 filed Sep. 27, 2023, the entire contents of which are hereby incorporated by reference for all purposes.

### TECHNICAL FIELD

The present disclosure relates to telemetry systems, and more particularly, to a telemetry system including an array of sensor stations and an aerial data collection system.

### BACKGROUND

Telemetry refers to the automatic collection, transmission, and analysis of data from remote sources, using sensors and other devices to collect data. A telemetry system commonly includes multiple sensors that transmit respective sensor data back to a central location for analysis.

Telemetry systems are used in numerous industries and applications, for example agriculture, construction, mining, renewable energy, and so on. Conventional telemetry systems are often influenced by physical obstructions or other unwanted limitations on wireless transmissions, often resulting in expensive designs for effective communication of sensor data.

In the field of agriculture, telemetry systems are used for collecting sensor data regarding various soil parameters, for example moisture, temperature, and Ph, to manage the use of land, water, and chemicals for growing crops. However, communicating sensor data in an agricultural environment can be difficult with existing telemetry systems. Some systems include a distributed array of sensor stations in a crop field, wherein each sensor station has an antenna to transmit sensor data to a central base station or gateway. However, “vegetation attenuation” often constrains the useful location of sensor stations, requiring expensive solutions. Vegetation attenuation refers to the attenuation effect of vegetation (plants), especially properly hydrated vegetation, within the wireless communication pathways of a wireless system. Vegetation attenuation is additive across distance and can substantially reduce link-margin in the relevant system.

To avoid this problem, agriculture antennae in an agricultural setting are often elevated (thereby allowing unobstructed communications over the relevant vegetation), which typically requires expensive, permanently installed structures. The elevated antenna may transmit respective sensor data laterally to a Sub-GHz proprietary network (e.g., Long Range Radio (LoRA)) or a traditional cellular network, for example. Additionally, cellular coverage is often unavailable or unreliable in farming locations.

Accordingly, there is a need for improved telemetry systems.

### SUMMARY

The present disclosure provides a telemetry system including an aerial data collection system, e.g., carriable by a drone, to collect sensor data from an array of sensor stations distributed (spaced apart) in a respective setting, e.g., an agricultural environment. As used herein, a “drone” refers to an unmanned arial vehicle (UAV).

In some examples, the telemetry system includes an array of sensor stations and an aerial data collection system. The sensor stations are arranged in a spaced apart arrangement. Respective sensor stations may be located at or near at least one object of interest to be monitored. An “object of interest” may include a physical object, a location or area in space (e.g., the air at a particular location), or any other entity having at least one sensible (i.e., sensor-detectable) characteristic.

In some examples, a respective sensor station may include (among other components) at least one sensor to generate sensor data regarding a respective object of interest, a sensor station memory to store the respective sensor data, a sensor station antenna, a sensor station wireless transmitter to transmit sensor data (e.g., for collection by the aerial data collection system), and a sensor station processor to execute logic instructions perform various functions, including periodically activating the wireless transmitter to transmit sensor data via the antenna.

The aerial data collection system may include (among other components) an aerial data collection system antenna, and an aerial data collection system receiver to receive respective sensor data transmitted by the respective sensor station antennas of respective sensor stations in the sensor station array. The aerial data collection system may be carriable by a drone, and may thus be referred to herein as a “drone-based aerial data collection system.” The aerial data collection system being “carriable” by the drone may include, for example, the aerial data collection system being manufactured or otherwise provided integral with the drone, or the aerial data collection system being produced separately from the drone and able to be secured to the drone (e.g., during manufacturing of the drone or retrofit to an existing drone) in any suitable manner. In some examples, the drone may be a commercial off-the-shelf (COTS) drone, and the aerial data collection system may be provided in an enclosure compatible with a gimbal camera mount provided on the COTS drone.

The telemetry system may utilize Bluetooth, radio frequency (RF), or any other suitable wireless communication protocol or protocols for communications between respective sensor stations and the aerial data collection system, including communication of data (e.g., sensor data and/or sensor station identification data) from respective sensor stations to the aerial data collection system and/or communication of data (e.g., drone identification data) from the aerial data collection system to respective sensor stations.

In some examples, the telemetry system may utilize a feature of the Bluetooth Low Energy (BLE) protocol called the “advertising packet” for transmitting sensor data from respective sensor stations to the aerial data collection system, which may avoid the need for pairing or handshaking between the respective sensor stations and aerial data collection system. In some examples, respective sensor stations may transmit sensor data (e.g., encoded in BLE advertising packets) either periodically or in response to a defined triggering event (e.g., a detection of the aerial data collection system flying overhead).

In some examples the sensor station antennas of respective sensor stations comprise directional antennas orientated upwardly to communicate with the drone-based aerial data collection system. In some examples, respective sensor stations may include a Yagi-Uda printed circuit board (PCB) antenna or other directional antennas (or other high-gain antenna) connected to a BLE transmitter to transmit sensor data (encoded in the BLE advertising packets) vertically (i.e., upwardly) at a high gain. The vertical transmission may reduce or eliminate signal attenuation potentially caused by nearby objects or structures. For example, in an agricultural implementation in which the sensor stations are arranged within a field of crops, the vertical transmission may reduce signal attenuation caused by vegetation extending above the height of respective sensor stations.

The drone-based aerial data collection system may include a corresponding BLE receiver and high-gain antenna, and may be programmed to fly in a pre-defined flight path (e.g., a zig-zag flight path) over the sensor station array. In some implementations, the pre-defined flight path may include serial way-points established upon installation or provisioning of respective sensos stations (e.g., using a mobile device) and associated GNSS data to be subsequently loaded as waypoints used by the aerial data collection system. Along the pre-defined flight path, the aerial data collection system may listen for BLE advertising packets from respective underlying sensor stations, and correlate received sensor data with respective sensor station identification information (e.g., unique sensor station identifiers and/or GNSS location data for respective sensor stations). Upon the drone's return to a home base location, the aerial data collection system may upload collected sensor data along with corresponding sensor station identification information (and timestamp information) to a back-end system, for example an application on a mobile device, a BLE gateway, a cellular network, or an internet connected network (e.g., WiFi network or other internet connected network), without limitation.

In some examples, respective sensor stations take sensor measurements (i.e., generating sensor data) according to a first frequency (e.g., hourly) and transmit sensor data for collection by the drone-based aerial data collection system according to a lower second frequency (e.g., daily). In some examples, the timing of sensor data transmission from sensor stations to the aerial data collection system may be correlated to the local sunset by using photodetectors (photodiodes) provided at least at the respective sensing stations. In other examples, the timing of sensor data transmission by respective sensor stations may be synchronized with a flight time or location of the aerial data collection system using clocks, e.g., respective real time clocks provided in the respective sensor stations and aerial data collection system.

In some examples a telemetry system as disclosed herein may be implemented in an agricultural environment, e.g., in an area in which surrounding vegetation and/or topography attenuates or otherwise hinders traditional ground-level, lateral transmission using conventional methods. In an agricultural implementation, farmers may enjoy greater yields by having better data on actual soil conditions and making more informed investments in crops. Agricultural seed/chemical companies may obtain better soil data for evaluating results of various treatments solutions. Crop insurance providers may obtain better data on historical soil conditions, e.g., to adjust premiums and claim compensations based on the soil care of respective farmers.

In other examples a telemetry system as disclosed herein may be implemented in any other type of environment, e.g., for monitoring a construction environment, a mining environment, a large recreational area (e.g., a golf course), geological or environmental data, a large-scale renewable energy installation telemetry, for utility metering, for surveillance purposes, or for military, space, or interplanetary applications, without limitation.

One aspect provides a telemetry system including an array of sensor stations arranged in a spaced apart arrangement, and an aerial data collection system. Respective ones of the array of sensor stations include a respective sensor to generate respective sensor data regarding an object of interest, a respective sensor station memory to store the respective sensor data, a respective sensor station antenna, a respective sensor station wireless transmitter, and a respective sensor station processor to periodically activate the respective sensor station wireless transmitter to transmit the respective sensor data via the respective sensor station antenna. The aerial data collection system includes an aerial data collection system antenna, and an aerial data collection system receiver to receive the respective sensor data transmitted by the respective sensor station antenna.

In some examples, the aerial data collection system includes an aerial data collection system memory, and an aerial data collection system processor to store, in the aerial data collection system memory, the respective sensor data received by the aerial data collection system receiver.

In some examples, the aerial data collection system is carriable by a drone.

In some examples, respective ones of the array of sensor stations include a respective sensor station photodetector to detect visible radiation, and logic instructions executable by the respective sensor station processor to periodically activate the respective sensor station wireless transmitter in response to the radiation detected by the respective sensor station photodetector.

In some examples, for respective ones of the array of sensor stations, the respective sensor station memory stores a respective sensor station identifier associated with the respective sensor station, and the respective sensor station wireless transmitter to transmit the first sensor station identifier with the first sensor data via the first sensor station antenna, and the aerial data collection system receiver to receive the respective sensor data and associated respective sensor station identifier transmitted by respective ones of the array of sensor stations.

In some examples, the respective sensor station wireless transmitter comprises a Bluetooth low energy (BLE) transmitter, and the aerial data collection system receiver comprises a BLE receiver.

In some examples, the telemetry system includes logic instructions executable by the first sensor station processor to encode the first sensor data in BLE advertising packets.

In some examples, the array of sensor stations are arranged at ground level.

In some examples, the first sensor station includes logic instructions executable by the first sensor station processor to selectively switch the first sensor station between multiple sensor station operational states including (a) a sleep state in which the first sensor and the first sensor station wireless transmitter are deactivated, (b) a periodic sensing state in which (i) the first sensor is activated to generate the first sensor data, wherein the first sensor data is stored in the first sensor station memory, and (ii) the first sensor station wireless transmitter is deactivated. and (c) a periodic wireless communication state in which the first sensor station wireless transmitter is activated to transmit the first sensor data stored in the first sensor station memory via the first sensor station antenna.

In some examples, the first sensor station antenna comprises a directional antenna arranged to transmit vertically.

In some examples, the array of sensor stations includes a first sensor station including a first sensor to generate second sensor data regarding a first object of interest, and a second station sensor including a second sensor to generate second sensor data regarding a second object of interest, and the aerial data collection system receiver to receive (a) the first sensor data from the first sensor station and (b) the second sensor data from the second sensor station.

One aspect provides a sensor station including a sensor to generate first sensor data regarding a first object of interest, a memory to store the first sensor data, an antenna, a wireless transmitter, a processor to periodically activate the wireless transmitter to transmit the sensor data via the antenna, and logic instructions executable by the processor to selectively switch the sensor station between multiple sensor station operational states including (a) a sleep state in which the sensor and the wireless transmitter are deactivated, (b) a periodic sensing state in which (i) the sensor is activated to generate the sensor data, wherein the generated sensor data is stored in the memory, and (ii) the wireless transmitter is deactivated, and (c) a periodic wireless communication state in which the wireless transmitter is activated to access and transmit the sensor data stored in the memory via the antenna. The sensor station also includes logic instructions executable by the processor to selectively switch the sensor station to the periodic wireless communication state in response to detecting a presence of a drone-based aerial data collection system.

In some examples, the sensor station includes a wireless transceiver including the wireless transmitter, and logic instructions executable by the processor to detect the presence of the drone-based aerial data collection system based on signals received at the wireless transceiver from the drone-based aerial data collection system.

In some examples, the sensor station includes a photodetector to detect radiation, and logic instructions executable by the processor to periodically activate the wireless transmitter in response to the radiation detected by the photodetector.

In some examples, the first sensor station wireless transmitter comprises a Bluetooth low energy (BLE) transmitter, and the sensor station includes logic instructions executable by the processor to encode the sensor data in BLE advertising packets.

In some examples, the logic instructions are executable by the processor to switch the sensor station to the periodic sensing state according to a first frequency, and switch the sensor station to the periodic wireless communication state according to a second frequency lower than the first frequency.

In some examples, the sensor station includes a wireless receiver to receive and identify a communication from an aerial data collection system, and logic instructions executable by the processor to activate the wireless transmitter in response to an identification of the communication from the aerial data collection system.

One aspect provides a sensor station, including a sensor to generate sensor data regarding a sensed entity, an antenna, a Bluetooth low energy (BLE) transmitter, and a processor to encode the sensor data in a BLE advertising packet and periodically activate the BLE transmitter to transmit the sensor data via the antenna.

In some examples, the sensor station includes a memory to store the sensor data generated by the sensor, and logic instructions executable by the processor to selectively switch the sensor station between multiple sensor station operational states including (a) a sleep state in which the sensor and the BLE transmitter are deactivated, (b) a periodic sensing state in which (i) the sensor is activated to generate the sensor data, wherein the generated sensor data is stored in the memory, and (ii) the BLE transmitter is deactivated, and (c) a periodic wireless communication state in which the BLE transmitter is activated to access and transmit the sensor data stored in the memory via the antenna.

One aspect provides an aerial data collection system, including a navigation system to navigate an aerial device carrying the aerial data collection system along a defined aerial route over an array of sensor stations, an antenna, and a Bluetooth low energy (BLE) receiver to receive BLE transmissions from the array of sensor stations via the antenna, wherein a respective BLE transmission from a respective sensor station in the array of sensor stations includes respective sensor data encoded in a BLE advertising packet.

In some examples, the aerial data collection system includes a memory, a processor, and logic instructions executable by the processor to identify the respective sensor data encoded in respective BLE advertising packets received by the BLE receiver, and to store the identified respective sensor data in the memory.

### DESCRIPTION OF THE DRAWINGS

Example aspects of the present disclosure are described below in conjunction with the figures, in which:

FIG. 1 shows an example telemetry system including a sensor station array and a drone-carriable aerial data collection system, according one example;

FIG. 2 shows an example sensor station of the example telemetry system shown in FIG. 1;

FIG. 3 shows an example aerial data collection system of the example telemetry system shown in FIG. 1;

FIG. 4 shows another example sensor station, including a BLE transceiver, for use in the example telemetry system shown in FIG. 1;

FIG. 5 shows another example aerial data collection system, including a BLE transceiver, for use in the example telemetry system shown in FIG. 1;

FIGS. 6A-6D show timing diagrams for two example operational protocols that may be implemented by a respective sensor station; and

FIGS. 7A-7C show timing diagrams for two example operational protocols that may be implemented by an example drone-carriable aerial data collection system.

It should be understood that the reference number for any illustrated element that appears in multiple different figures has the same meaning across the multiple figures, and the mention or discussion herein of any illustrated element in the context of any particular figure also applies to each other figure, if any, in which that same illustrated element is shown.

### DETAILED DESCRIPTION

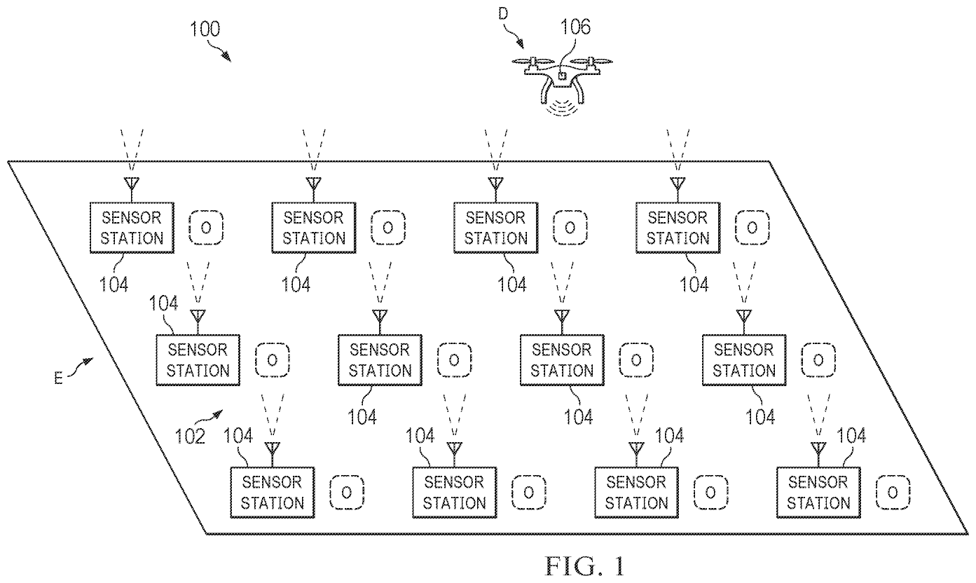

FIG. 1 shows an example telemetry system 100 for monitoring an environment E, according to one example. The example telemetry system 100 includes a sensor station array 102 including an array of sensor stations 104 arranged spaced apart in the environment E, and an aerial data collection (ADC) system 106, which may be carriable by a drone D, e.g., to periodically fly over the sensor station array 102 to wirelessly collect sensor data generated by the respective sensor stations 104. Respective sensor stations 104 may be located at or near at least one respective object of interest “O” to be monitored. As noted above, an object of interest O (or simply “object O” for convenience) may include a physical object, a location or area in space (e.g., the air at a particular location), or any other entity having at least one sensible (i.e., sensor-detectable) characteristic. In some examples, as discussed in more detail below, respective sensor stations 104 may be installed or arranged at ground level and respectively include an antenna to transmit directionally in an upward direction, e.g., to reduce attenuation caused by nearby structures or growths and/or otherwise increase signal gain.

In an example implementation in which the telemetry system 100 is provided in an agricultural setting (referred to herein as an “agricultural implementation”), objects O in the environment E may include, for example, (a) an area of soil (wherein the respective sensor station 104 measures various soil parameter(s), e.g., moisture, temperature, and/or pH, without limitation), (b) a nearby region of air (wherein the respective sensor station 104 measures various characteristics of the local air(s), e.g., humidity, temperature, and/or wind speed and direction, without limitation), (c) nearby vegetation (e.g., moisture, vegetation density, and/or “greenness,” without limitation), and/or any other suitable sensor-detectable parameter(s).

FIG. 2 shows an example sensor station 104 of the sensor station array 102 of the example telemetry system 100 shown in FIG. 1. As shown, the sensor station 104 may include (among other components) at least one sensor 200 to generate respective sensor data 202 regarding at least one respective sensed parameter of at least one object O, a sensor station memory 206 to store the respective sensor data 202, a sensor station antenna 208, a sensor station wireless transmitter 210 communicatively connected to the sensor station antenna 208, and a sensor station processor 212 communicatively connected to the sensor station memory 206 and sensor station wireless transmitter 210.

Sensor(s) 200 may include one or more types of sensors, e.g., including analog sensor(s) and/or digital sensor(s), to measure one or more sensible parameters of at least one object O. Example types of sensors 200 may include a proximity sensor, temperature sensor (e.g., thermocouple), moisture/humidity sensor, pH sensor, audio sensor (e.g., a microphone), photodetector, density sensor, pressure, sensor, voltage sensor, current sensor, capacitive sensor, inductance sensor, resistive sensor, infrared sensor, ultrasonic sensor, gas sensor, color sensor, flow sensor, smoke sensor, or any other type of sensor.

In some examples, the sensor station antenna 208 may comprise a directional antenna orientated upwardly to communicate with the ADC system 106 flying overhead. In some examples, the sensor station antenna 208 may comprise a Yagi-Uda printed circuit board (PCB) antenna or other directional antenna, or other high-gain antenna. The sensor station wireless transmitter 210 connected to the sensor station antenna 208 may include circuitry for transmitting data (including sensor data 202 and/or other data) via the sensor station antenna 208 according to any communication protocol. For example, sensor station wireless transmitter 210 may include circuitry to transmit data via Bluetooth protocols. In one example, sensor station wireless transmitter 210 comprises a BLE transmitter including circuitry to utilize BLE advertising packets for transmitting sensor data 202 and/or other data to the ADC system 106. The BLE transmitter may encode sensor data 202 and/or other data in the payload section of respective BLE advertising packets.

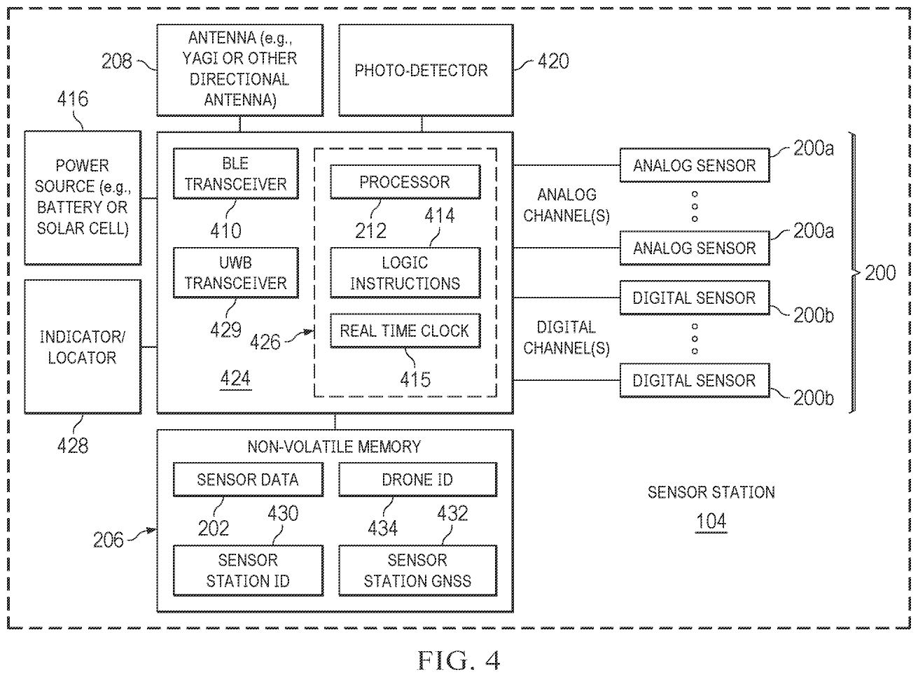

In some examples, in addition to transmitting data to the ADC system 106, the sensor station 104 may receive data transmitted by the ADC system 106. In such examples, e.g., as shown in the example of FIG. 4 discussed below, the sensor station 104 may comprise a wireless transceiver connected to the sensor station antenna 208, wherein the sensor station wireless transmitter 210 comprises the transmitter circuitry of the wireless transceiver, and the wireless transceiver further includes receiver circuitry to receive data transmitted by the ADC system 106. Alternatively, the sensor station 104 may comprise a separate wireless receiver (e.g., separate from the wireless transmitter 210), which may be connected to the sensor station antenna 208 or a separate antenna.

The sensor station processor 212 may execute respective logic instructions (e.g., implemented in software and/or firmware stored in computer-readable memory) to perform various functions of the sensor station 104, including (a) periodically activating respective sensor (2) 200 to take respective sensor measurements (i.e., to generate respective sensor data 202), (b) periodically activating the sensor station wireless transmitter 210 to transmit sensor data 202 via the sensor station antenna 208, e.g., for receipt by the ADC system 106, and/or (c) any other various functions of the sensor station 104.

In some examples, the sensor station processor 212 may execute respective logic instructions to selectively switch the sensor station 104 between different operational states (also referred to as “sensor station operational states”), for example including (a) a “sleep state” in which respective sensor(s) 200 and the sensor station wireless transmitter 210 are deactivated; (b) a “periodic sensing state” in which in which (i) respective sensor(s) 200 is/are activated to generate respective sensor data 202 (which generated sensor data 202 may be stored in sensor station memory 206) and (ii) the sensor station wireless transmitter 210 is deactivated; and (c) a “periodic wireless communication state” in which the sensor station wireless transmitter 210 is activated to access and transmit sensor data 202 stored in sensor station memory 206 via the sensor station antenna 208, e.g., for receipt by the ADC system 106.

In some examples, the sensor station processor 212 switches the sensor station 104 to the periodic sensing state according to a first frequency (e.g., hourly), and switches the sensor station 104 to the periodic wireless communication state according to a lower, second frequency (e.g., daily). In some examples, the sensor station processor 212 switches the sensor station 104 to the periodic wireless communication state in coordination with a flight of the drone-based ADC system 106 over the sensor station array 102, as discussed below. For example, e.g., as discussed below with reference to FIGS. 4, 5, 6C, 6D, and 7C, the sensor station processor 212 and ADC system 106 may perform a clock-based coordination of respective drone flights with the transmission of sensor data 202 from the sensor station 104, e.g., using respective real-time clocks (RTCs) provided in the ADC system 106 and sensor station 104. As another example, e.g., as discussed below with reference to FIGS. 4, 5, 6A, 6B, 7A, and 7B, the sensor station 104 may include a photodetector to detect a local sundown time, and synchronize respective transmission of sensor data 202 from the sensor station 104 with detection of local sundown. ADC system 106 may be similarly outfitted with a photodetector, or may be timed to collect data at local sundown.

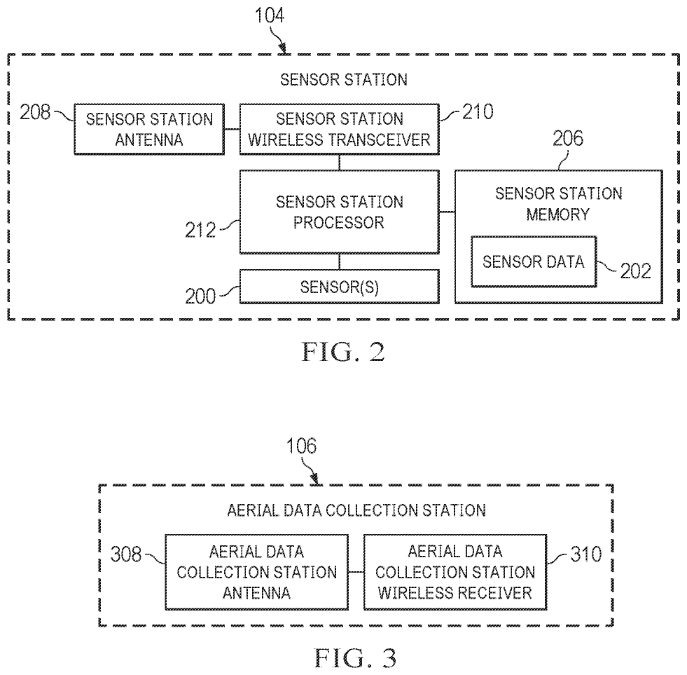

FIG. 3 shows an example aerial data collection (ADC) system 106 of the example telemetry system 100 shown in FIG. 1. As shown, the drone-based ADC system 106 may include (among other components) an ADC system antenna 308 (or antenna 308 for convenience) and an ADC system wireless receiver 310 (or wireless receiver 310 for convenience) connected to the antenna 308 to receive respective sensor data 202 transmitted by respective sensor station antennas 208 of respective sensor stations 104.

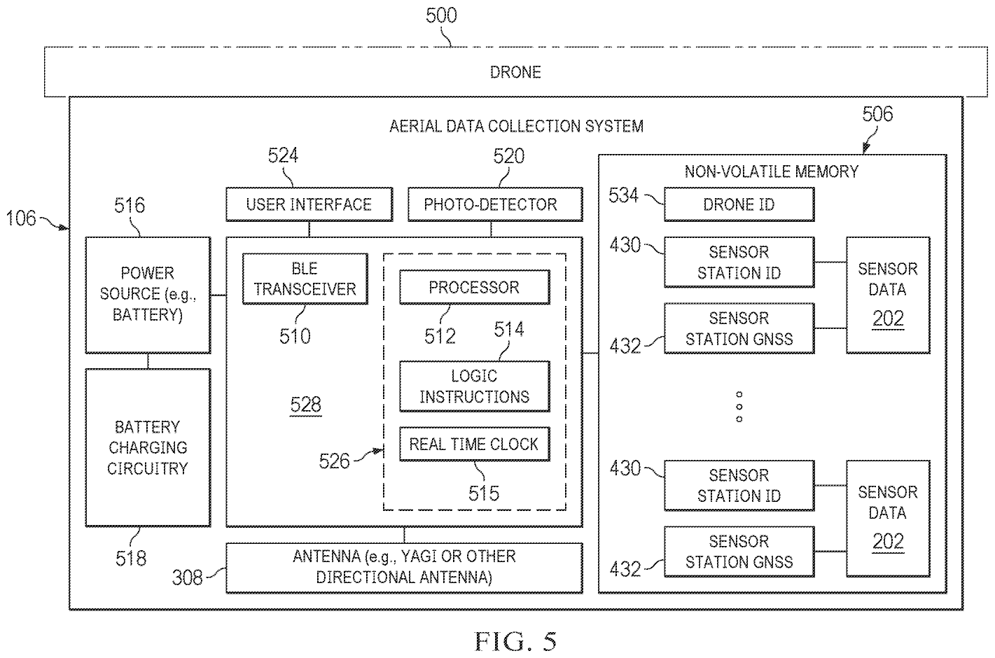

The wireless receiver 310 connected to the antenna 308 may include circuitry for receiving data, e.g., including sensor data 202 and/or other data transmitted by respective sensor stations 104, via the antenna 308 according to any communication protocol. For example, wireless receiver 310 may include circuitry to receive data via Bluetooth protocols, e.g., BLE communications. In some examples, in addition to receiving data transmitted by sensor stations 104, the ADC system 106 may transmit data wirelessly for receipt by respective sensor stations 104, for example data identifying the presence of the ADC system 106 flying over the respective sensor stations 104 and/or identification information identifying the ADC system 106 or the drone carrying the ADC system 106, without limitation. In such examples, e.g., as shown in the example of FIG. 5 discussed below, the ADC system 106 may comprise a wireless transceiver connected to the antenna 308, wherein the wireless receiver 310 comprises the receiver circuitry of the wireless transceiver, and the wireless transceiver further includes transmitter circuitry to transmit data for receipt by respective sensor stations 104. Alternatively, the ADC system 106 may comprise a separate wireless transmitter (e.g., separate from the wireless receiver 310), which may be connected to the antenna 308 or a separate antenna.

In some examples, the ADC system 106 may be manufactured or otherwise provided integral with a drone. In other examples, the ADC system 106 may be produced separately from the drone and able to be secured to the drone (e.g., during manufacturing of the drone or retrofit to an existing drone) in any suitable manner. In some examples, the drone may be a commercial off-the-shelf (COTS) drone, and the ADC system 106 may be secured to a camera mount connection provided on the drone, or provided in an enclosure compatible with a gimbal camera mount provided on the drone. In some examples, the ADC system 106 may be otherwise securable to the drone.

FIG. 4 shows another example sensor station 104 of the sensor station array 102 of the example telemetry system 100 shown in FIG. 1. As shown, the sensor station 104 shown in FIG. 4 may include multiple sensors 200 to generate respective sensor data 202 regarding at least one respective sensed parameter of at least one object O, a sensor station memory 206, a sensor station antenna 208, a BLE transceiver 410 (including transmitter circuitry and receiver circuitry), a processor 212, logic instructions 414, a real time clock (RTC) 415, a power source 416, and an optional photodetector 420. In this example, the processor 212, logic instructions 414, and RTC 415 may be implemented in a microcontroller 426 provided with the BLE transceiver 410 in a system-on-chip (SoC) 424. Logic instructions 414 may be embodied in software and/or firmware stored in computer-readable memory. BLE transceiver 410 may be replaced with another RF transceiver without exceeding the scope. As used herein, a “transceiver” includes both transmitting circuitry and receiving circuitry, which may be provided in a combined transceiver device or may be provided as distinct transmitter and receiver devices.

Sensors 200 may include any types of sensors to measure any sensible parameters of at least one object O, e.g., any sensor types discussed above regarding sensors 200. In this example, sensors 200 include one or more analog sensors 200a and one or more digital sensors 200b.

Sensor station memory 206 may comprise a non-volatile memory device (e.g., at least one ROM, EPROM, EEPROM, or Flash memory) to store sensor data 202 generated by sensors 200, (optional) sensor station ID data 430, (optional) sensor station global navigation satellite system (GNSS) data 432, (optional) drone ID data 434, and/or any other data.

Sensor station ID data 430 may include, for example (a) a unique identifier for identifying the respective sensor station 104 (e.g., unique from other sensor stations in the sensor station array 102) and/or (b) information identifying the sensor station array 102 in which the respective sensor station 104 is included. Sensor station GNSS data 432 may include GNSS location data identifying the location of the respective sensor station 104, which GNSS data 432 may be recorded and stored in sensor station memory 206 during the installation of the respective sensor station 104 in the sensor station array 102, for example. The respective sensor station 104 may wirelessly transmit sensor data 202, sensor station ID data 430 and/or sensor station GNSS data 432 (e.g., encoded in BLE advertising packets) for receipt by the ADC system 106. The ADC system 106 (or a back-end computer system to which the ADC system 106 uploads its collected data) may link sensor data 202 received from respective sensor stations 104 with the respective sensor station ID data 430 and/or sensor station GNSS data 432 associated with the respective sensor stations 104.

Drone ID data 434 may include identification information for one or more ADC system or drone. The respective sensor station 104 may compare information received from a respective ADC system 106 with the stored drone ID data 434 to identify and/or authenticate the ADC system 106, e.g., to trigger or authorize a transmission of sensor data 202 to the ADC system 106.

In this example, the sensor station antenna 208 may include a Yagi-Uda printed circuit board (PCB) antenna or other directional antenna (or other high-gain antenna) connected to the BLE transceiver 410. The BLE transceiver 410, via the antenna 208, may (a) wirelessly transmit sensor data 202, sensor station ID data 430 and/or sensor station GNSS data 432 (encoded in BLE advertising packets), and (b) wirelessly receive an advertising beacon indicating the overhead presence of ADC system 106 and/or drone ID data 534 (discussed below) for identifying and/or authenticating a detected ADC system 106 (e.g., by comparing received drone ID data 534 with locally stored drone ID data 434).

The power source 416 for the respective sensor station 104 may comprise a battery, a solar cell, mains electricity, or any other suitable power source.

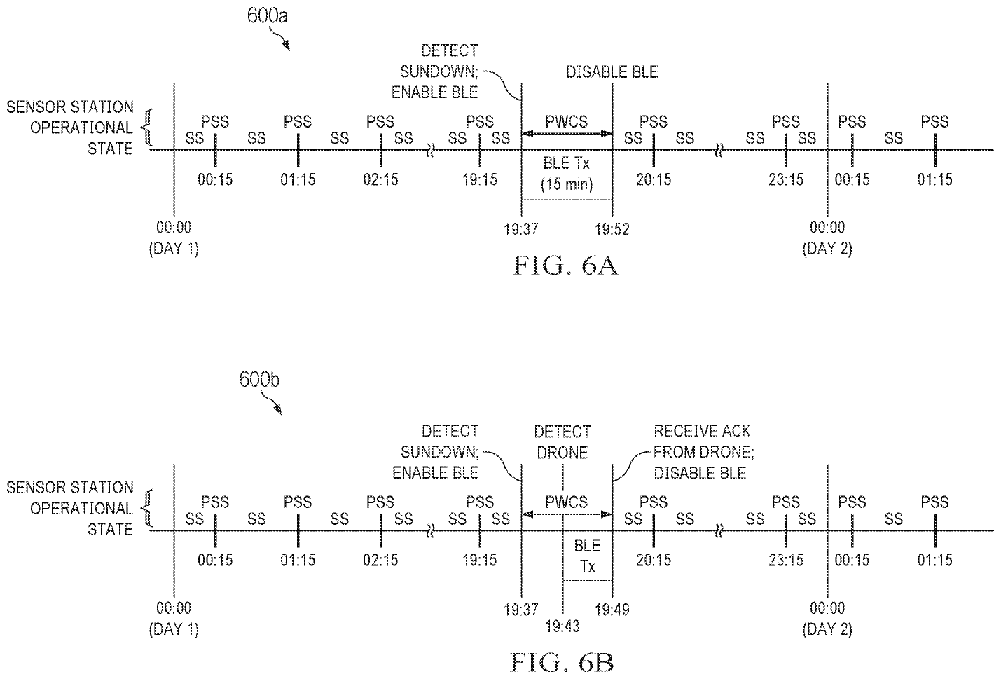

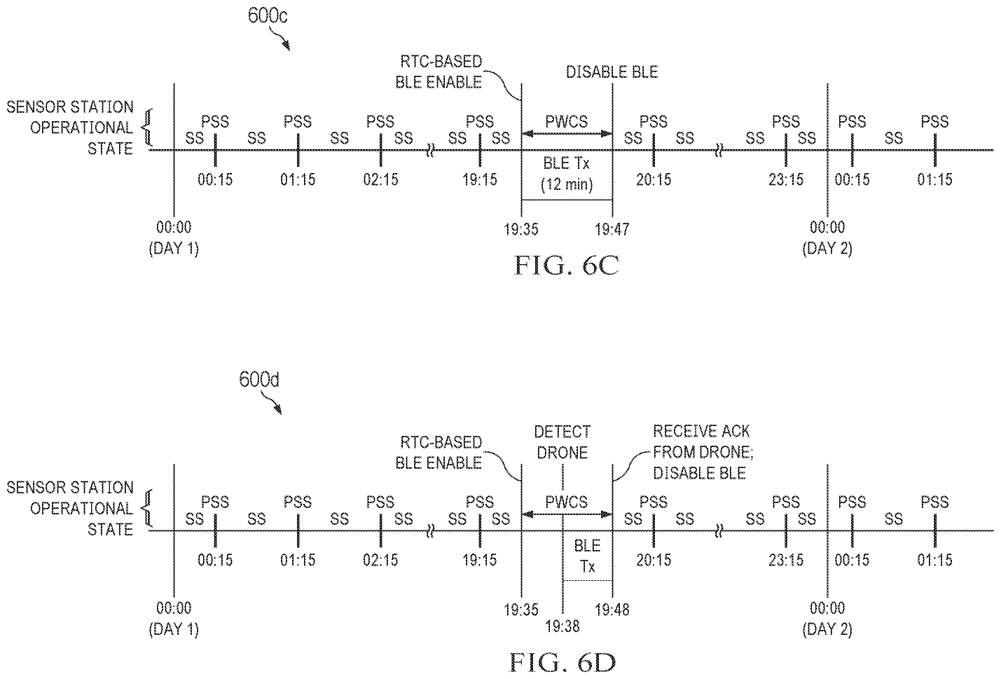

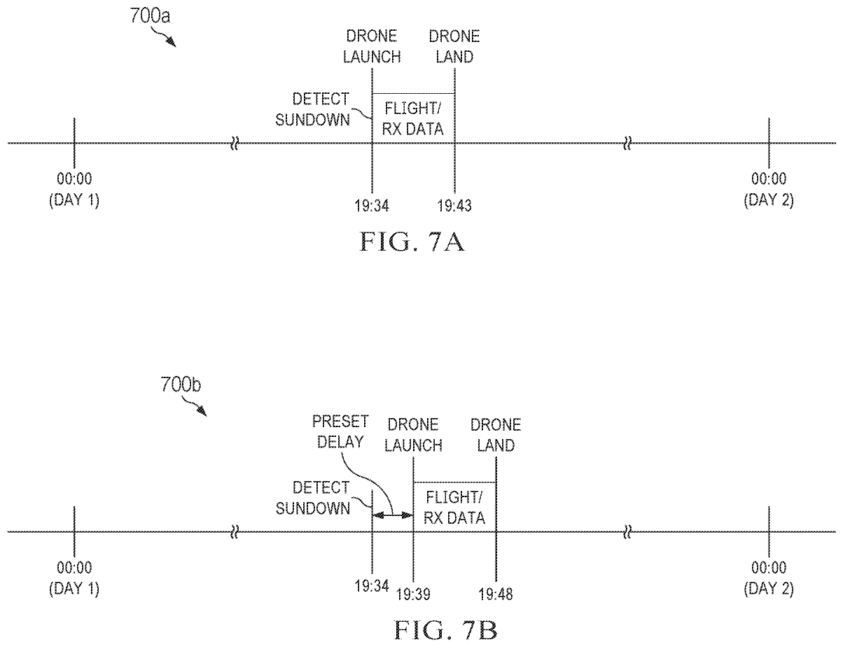

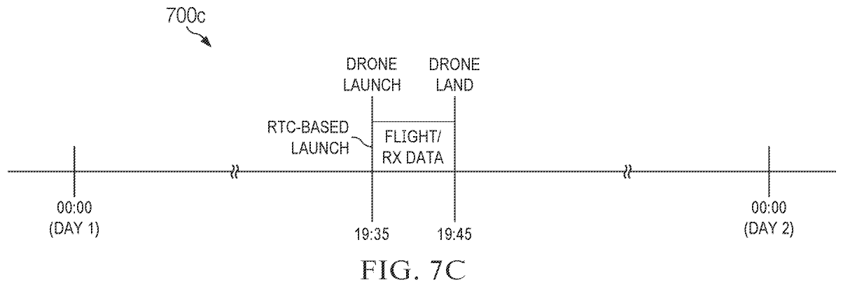

The optional photodetector 420 may be provided in some examples for synchronizing transmissions of sensor data 202 with flights of the drone-based ADC system 106 over the respective sensor station 104, e.g., as an alternative or supplement to clock-based synchronization using the RTC 415 and/or the RTC 515 of the ADC system 106. For example, the respective sensor station 104 may use the photodetector 420, and the ADC system 106 may use a respective photodetector 520 (shown in FIG. 5, discussed below), to respectively detect a defined level of daylight (e.g., sundown), and use such detected light level to coordinate a flight of the drone-based ADC system 106 with transmission(s) of sensor data 202 from the respective sensor station 104, for example as discussed below with reference to FIGS. 6A-6B and FIGS. 7A-7B. Alternately, the respective sensor station 104 may use the photodetector 420 to respectively detect a defined level of daylight (e.g., sundown), and use such detected light level to initiate transmission(s) of sensor data 202 for a predetermined amount of time.

In some examples, the sensor station 104 may include an indicator/locator 428 to facilitate a locating or finding of the sensor station 104 by a human or other automated system, for example to decommission, remove, re-locate, or program/reprogram the sensor station 104. For example, the indicator/locator 428 may help a user find the sensor station 104 in a situation in which the sensor station 104 is visually obstructed (e.g., by vegetation in an agricultural implementation). The indicator/locator 428 may comprise light(s), an audio speaker, or other device to output visual, audible, or other sensible output.

As discussed below with reference to FIG. 5, in some examples the ADC system 106 may include circuitry (e.g., embodied in logic instructions 514) to transmit signals to respective sensor stations 104 (e.g., encoded in BLE advertising packets) to activate the indicators/locators 428 of the respective sensor stations 104. In addition or alternatively, the ADC system 106 may include circuitry (e.g., embodied in logic instructions 514) to transmit signals to respective sensor stations 104 (e.g., encoded in BLE advertising packets) to otherwise control or adjust the operation of respective sensor stations 104, e.g., to control or adjust measurement protocols implemented by respective sensors 200, or to control or adjust times or frequencies of sensor measurements or other operations of respective sensor stations 104 (e.g., controlling or adjusting respective times or frequencies of activating respective sensors 200, enabling or disabling the BLE transceiver 410, or transmitting respective sensor data 202 by respective sensor stations 104).

In some examples, a local ground-based system may locate the respective sensor stations 104 using Angle of Arrival (AoA) and/or Angle of Departure (AoD) provided in the BLE protocol, or using Ultra Wideband (UWB) signaling, or other signaling. Thus, in some examples respective sensor stations 104 may include a UWB transceiver 429 as shown in FIG. 4. The ADC system 106 may include circuitry (e.g., embodied in logic instructions 514) to transmit signals to respective sensor stations 104 (e.g., encoded in BLE advertising packets) to activate or control a respective transceiver (e.g., BLE transceiver 410 or UWB transceiver 429) allowing the ground-based system to locate the respective sensor stations 104 (e.g., at the end of the useful lifetime of the respective sensor stations 104).

FIG. 5 shows another example ADC system 106 of the example telemetry system 100 shown in FIG. 1. As shown, the example ADC system 106 may be carriable by a drone 500. The ADC system 106 may include an ADC system memory 506, an ADC system antenna 308, a BLE transceiver 510 (including transmitter circuitry and receiver circuitry), a processor 512, logic instructions 514, a real time clock (RTC) 515, a power source 516, an optional battery charging circuitry 518, an optional photodetector 520, and a user interface 524. In this example, the processor 512, logic instructions 514, and RTC 515 may be implemented in a microcontroller 526 provided with the BLE transceiver 510 in a system-on-chip (SoC) 528. Logic instructions 514 may be embodied in software and/or firmware stored in computer-readable memory. BLE transceiver 510 may be replaced with another RF transceiver without exceeding the scope.

As discussed above with reference to FIG. 4, in some examples the ADC system 106 may include circuitry (e.g., embodied in logic instructions 514) to transmit signals to respective sensor stations 104 (e.g., encoded in BLE advertising packets) to activate the indicators/locators 428 of the respective sensor stations 104 to facilitate a locating or finding of the respective sensor stations 104.

As further discussed above with reference to FIG. 4, in some examples the ADC system 106 may include circuitry (e.g., embodied in logic instructions 514) to transmit signals to respective sensor stations 104 (e.g., encoded in BLE advertising packets) to activate or control respective transceivers in respective sensor stations 104 (e.g., BLE transceivers 410 or UWB transceivers 429) allowing a ground-based system to locate the respective sensor stations 104.

ADC system memory 506 may comprise a non-volatile memory device (e.g., at least one ROM, EPROM, EEPROM, or Flash memory) to store drone ID data 534 and data received from respective sensor stations 104, including sensor data 202, sensor station ID data 430, and/or sensor station GNSS data 432, and any other data. As shown, the ADC system 106 may link the respective sensor station ID data 430 and/or sensor station GNSS data 432 corresponding with the respective sensor data 202 received from respective sensor stations 104.

Drone ID data 534 may include unique identification information for the ADC system 106 or drone 500. ADC system 106 may transmit drone ID data 534 for receipt by respective sensor stations 104, which may compare such drone ID data 534 with locally stored drone ID data 434 to identify and/or authenticate the ADC system 106, e.g., to trigger or authorize a transmission of respective sensor data 202 to the ADC system 106.

The ADC antenna 308 may include a Yagi-Uda printed circuit board (PCB) antenna or other directional antenna, e.g., oriented in a downward direction. Alternatively, the ADC antenna 308 may comprise an omnidirectional antenna. The BLE transceiver 510, via the antenna 308, may (a) wirelessly transmit an advertising beacon (indicating the presence of ADC system 106 to respective sensor stations 104), drone ID data 534 and/or other data (e.g., encoded in BLE advertising packets) to respective sensor stations 104, and (b) wirelessly receive data from respective sensor stations 104, including respective sensor data 202, sensor station ID data 430 and/or sensor station GNSS data 432 (e.g., encoded in BLE advertising packets).

The power source 516 for the respective sensor station 104 may comprise a battery, solar cell, or any other suitable power source. The optional battery charging circuitry 518 may include circuitry for charging the power source 516, e.g., by connection to mains electricity (power grid).

The optional photodetector 520 may be provided in some examples for synchronizing flights of the drone-based ADC system 106 over the sensor station array 102 with transmissions of sensor data 202 by respective sensor stations 104, e.g., as an alternative or supplement to clock-based synchronization using the RTC 515 and/or respective RTCs 415 of respective sensor stations 104. For example, as discussed below with reference to FIGS. 6A-6B and FIGS. 7A-7B, the ADC system 106 and respective sensor stations 104 may respectively use photodetectors 520 and 420 to detect a defined level of daylight (e.g., sundown), and use such detected light level to coordinate a flight of the drone-based ADC system 106 with transmissions of sensor data 202 from the respective sensor station 104.

The user interface 524 may comprise an on-board interface allowing a user to view data related to or collected by the ADC system 106 and/or input commands, program the ADC system 106, or otherwise control the operation of the ADC system 106. For example, the user interface 524 comprises at least one display element (e.g., discrete LEDs or an LED display screen) and at least one user input device, e.g., a touchscreen display or discrete buttons, switches, or other actuators. In some examples, in addition to or alternative to an on-board interface as discussed above, the user interface 524 may comprise a wired or wireless connection interface for communicatively connecting an external computer (e.g., a laptop, tablet, smartphone, server, or cloud-based storage, without limitation) to the ADC system 106, e.g., allowing a user to (a) download collected sensor data 202 (with related sensor station ID data 430 and/or sensor station GNSS data 432) to the external computer or to another external computer (e.g., for analysis of the collected sensor data 202) and/or (b) program the ADC system 106 or otherwise control the operation of the ADC system 106.

Referring to FIGS. 4 and 5, in some examples respective actions of respective sensor stations 104 and the ADC system 106 may be coordinated or synchronized to transfer sensor data 202 from the respective sensor stations 104 to the ADC system 106 at selected times. In some examples, respective sensor stations 104 and the ADC system 106 may use respective photodetectors 420 and 520 to detect a local sundown (or other light-related event). The ADC system 106 (in particular the processor 512 executing respective logic instructions 514) may initiate a data collection flight of a drone 500 carrying the ADC system 106 in response to the sundown light level detected by photodetector 520, e.g., at the time of detecting the sundown light level or after a predetermined time delay. The data collection flight may follow a predefined flight path over the sensor station array 102, e.g., passing over respective sensor stations 104 according to a defined pattern.

Respective sensor stations 104 may initiate transmissions of sensor data 202 in response to the sundown light level detected by respective photodetectors 420. For example, upon detecting sundown, a respective sensor station 104 may (a) switch the respective sensor station 104 to the periodic wireless communication state, by enabling the BLE transceiver 410 and (b) initiate periodic transmissions (e.g., repeating every 10 seconds) of respective sensor data 202 stored in sensor station memory 206, and (c) continue such periodic transmissions of sensor date 202 for a predetermined time period (e.g., 10 minutes) or alternatively until receiving a notification from the ADC system 106 that the respective sensor data 202 has been received by the ADC system 106.

As another example, upon detecting sundown, the respective sensor station 104 may (a) switch the respective sensor station 104 to the periodic wireless communication state, by enabling the BLE transceiver 410; (b) after a predefined time delay (e.g., corresponding with an estimated time for the drone-based ADC system 106 to travel from a home base location to a position over the respective sensor station 104), initiate periodic transmissions (e.g., repeating every 10 seconds) of respective sensor data 202 stored in sensor station memory 206; and (c) continue such periodic transmissions of sensor date 202 for a predetermined time period (e.g., 10 minutes) or alternatively until receiving a defined notification from the ADC system 106 (e.g., indicating the ADC system 106 has received the respective sensor data 202 from the respective sensor station 104).

As another example, upon detecting sundown, the respective sensor station 104 may (a) switch the respective sensor station 104 to the periodic wireless communication state, by enabling the BLE transceiver 410; (b) operate the enabled BLE transceiver 410 to detect the ADC system 106 flying overhead (e.g., by receiving an advertising signal including drone ID data 534 and comparing with stored drone ID data 434 to identify or authenticate the ADC system 106); (c) upon detecting the ADC system 106, initiate periodic transmissions (e.g., repeating every 10 seconds) of respective sensor data 202 stored in sensor station memory 206, and (d) continue such periodic transmissions of sensor date 202 for a predetermined time period (e.g., 10 minutes) or alternatively until receiving a defined notification from the ADC system 106 (e.g., indicating the ADC system 106 has received the respective sensor data 202 from the respective sensor station 104).

In other examples, e.g., as discussed below with reference to FIGS. 6C, 6D, and 7C, the drone-based ADC system 106 and respective sensor stations 104 may perform a clock-based coordination (using respective RTCs 415 and 515) of drone flights with the enabling of respective BLE transceivers 410 and transmission of respective sensor data 202 by respective sensor stations 104.

FIGS. 6A-6D show timing diagrams for two example operational protocols 600a-600d, respectively, that may be implemented by a respective sensor station 104. The following discussion relates to an implementation using the example sensor station 104 shown in FIG. 4.

The example operational protocols 600a-600d define a respective progression through different operational states of the respective sensor station 104 discussed above, namely the sleep state (“ss”), periodic sensing state (“PSS”), and periodic wireless communication state (“PWCS”) through one example day (“Day 1”). FIGS. 6A-6D show example times for example transitions between the operational states of the respective sensor station 104. The example operational protocols 600a-600d may be respectively implemented by the sensor station processor 212 executing respective logic instructions 414.

In respective operational protocols 600a-600d, the sensor station 104 may be maintained in the sleep state (ss) except when transitioned to the periodic sensing state (PSS) or periodic wireless communication state (PWCS), e.g., to conserve battery usage. According to respective operational protocols 600a-600d, the sensor station 104 may be switched to the periodic sensing state (PSS) hourly (in the illustrated examples, at 15 minutes past each hour), during which respective sensor(s) 200 may generate sensor data 202 (by taking sensor measurements), and the generated sensor data 202 may be stored in sensor station memory 206, e.g., with respective timestamps. After completing the sensor measurements, the sensor station 104 may be switched back to the sleep state (ss).

The different example operational protocols 600a-600d differ with respect to transmitting sensor data 202 to the ADC system 106. As discussed below, the example operational protocols 600a and 600b utilize the optional photodetector 420 for triggering respective actions of the sensor station 104, whereas the example operational protocols 600c and 600d utilize the RTC 415 for triggering respective actions of the sensor station 104.

According to the operational protocol 600a shown in FIG. 6A, the sensor station 104 switches to the periodic wireless communication state (“PWCS”) (by enabling the BLE transceiver 410) upon detection of a defined sundown light level by the photodetector 420, and then switching back to the sleep state (ss) (by disabling the BLE transceiver 410) after a predefined time period, in this example 15 minutes. During the PWCS period, i.e., wherein the BLE transceiver 410 is enabled, the BLE transceiver 410 may transmit respective sensor data 202 encoded in BLE advertising packets (e.g., sensor data 202 generated in the past 24 hours, past 48 hours, or other time period) at a defined frequency, e.g., every 10 seconds, as indicated by “BLE Tx (15 min)” in FIG. 6A.

According to the operational protocol 600b shown in FIG. 6B (like the operational protocol 600a shown in FIG. 6A), the respective sensor station 104 switches to the periodic wireless communication state (“PWCS”) (by enabling the BLE transceiver 410) upon detection of a defined sundown light level by the photodetector 420. However, unlike the operational protocol 600a discussed above, according to the operational protocol 600b shown in FIG. 6B, the sensor station 104 awaits detection of the drone-based ADC system 106 before initiating transmission of sensor data 202. Upon detection of the drone-based ADC system 106 (e.g., by receiving an advertising signal at BLE transceiver 410 including drone ID data 534, and comparing the drone ID data 534 with stored drone ID data 434 to identify or authenticate the ADC system 106), the sensor station 104 may initiate transmission of respective sensor data 202 encoded in BLE advertising packets (e.g., sensor data 202 generated in the past 24 hours, past 48 hours, or other time period) at a defined frequency, e.g., every 10 seconds, as indicated by “BLE Tx” in FIG. 6B. In this example, the sensor station 104 may continue to transmit the respective sensor station 104 until receiving (by BLE transceiver 410) an acknowledgement message from the ADC system 106 indicating the ADC system 106 has successfully received the respective sensor data 202 transmitted by the respective sensor station 104. Upon receiving such acknowledgement message from the ADC system 106, the respective sensor station 104 switches back to the sleep state (ss) by disabling the BLE transceiver 410.

According to the operational protocol 600c shown in FIG. 6C, the respective sensor station 104 switches to the periodic wireless communication state (“PWCS”) (by enabling the BLE transceiver 410) at a first predefined time, using RTC 415, and then switching back to the sleep state (ss) (by disabling the BLE transceiver 410) at a second predefined time, in this example 12 minutes after switching to the PWCS (i.e., 12 minutes after enabling the BLE transceiver 410). The first and second predefined times (for enabling and disabling the BLE transceiver 410) may be synchronized with a predefined drone launch time implemented by the ADC system 106 using RTC 515. Referring to FIG. 6C, during the PWCS period, i.e., wherein the BLE transceiver 410 is enabled, the BLE transceiver 410 may transmit respective sensor data 202 encoded in BLE advertising packets (e.g., sensor data 202 generated in the past 24 hours, past 48 hours, or other time period) at a defined frequency, e.g., every 5 seconds, as indicated by “BLE Tx (12 min).”

In some examples, the predefined time for enabling the BLE transceiver 410 by the respective sensor station 104, or the predefined drone launch time implemented by the ADC system 106, may include a predefined delay (as opposed to being synchronized to the same time), for example to allow time for the ADC system 106 to fly from a home base location to a location over the respective sensor station 104, or to ensure the respective sensor station 104 has initiated transmission of respective sensor data 202 before the ADC system 106 reaches a location over the respective sensor station 104, without limitation.

According to the operational protocol 600d shown in FIG. 6D (like the operational protocol 600c shown in FIG. 6C), the respective sensor station 104 switches to the periodic wireless communication state (“PWCS”) (by enabling the BLE transceiver 410) at a predefined time, using RTC 415. However, unlike the operational protocol 600c discussed above, according to the operational protocol 600c shown in FIG. 6C, the sensor station 104 awaits detection of the drone-based ADC system 106 before initiating transmission of sensor data 202 (similar to the example operational protocol 600b discussed above). Upon detection of the drone-based ADC system 106 (e.g., by receiving an advertising signal at BLE transceiver 410 including drone ID data 534, and comparing the drone ID data 534 with stored drone ID data 434 to identify or authenticate the ADC system 106), the sensor station 104 may initiate transmission of respective sensor data 202 encoded in BLE advertising packets at a defined frequency, e.g., every 8 seconds, as indicated by “BLE Tx” in FIG. 6D. In this example, the sensor station 104 may continue to transmit the respective sensor station 104 until receiving (by BLE transceiver 410) an acknowledgement message from the ADC system 106 indicating the ADC system 106 has successfully received the respective sensor data 202 transmitted by the respective sensor station 104. Upon receiving such acknowledgement message from the ADC system 106, the respective sensor station 104 switches back to the sleep state (ss) by disabling the BLE transceiver 410.

The predefined time for enabling the BLE transceiver 410 may be synchronized with a predefined drone launch time implemented by the ADC system 106 using RTC 515, and may include a predefined delay (e.g., wherein the predefined time for enabling the BLE transceiver 410 or the predefined drone launch time implemented by the ADC system 106 is delayed by a predefined period), e.g., as discussed above regarding the example operational protocol 600c.

FIGS. 7A-7C show timing diagrams for example operational protocols 700a-700c, respectively, that may be implemented by an example ADC system 106. The following discussion relates to an implementation using the example ADC system 106 shown in FIG. 5. As discussed below, the example operational protocols 700a and 700b utilize the optional photodetector 520 for triggering a flight launch of the drone-based the ADC system 106, whereas the example operational protocol 700c utilize the RTC 515 for triggering the drone flight launch.

According to the example operational protocol 700a shown in FIG. 7A, the ADC system 106 initiates a flight launch upon detection of a defined sundown light level by the photodetector 520, which may not be the same defined sundown light level described above in relation to FIGS. 6A-6B, flies over at least one sensor station array 102 according to a defined flight path, collects respective sensor data 202 from respective sensor stations 104 (indicated as “Rx data”), and then returns to land. The example operational protocol 700b shown in FIG. 7B is similar to the example operational protocol 700a shown in FIG. 7A, but includes a present time delay (in this example, 5 minutes) between sundown detection and initiating the flight launch. The time delay may account for differences in sundown detection by photodetector 520 and photodetectors 420 of respective sensor stations 104, e.g., to increase the likelihood of the respective sensor stations 104 being in the periodic wireless communication state (PWCS) when the ADC system 106 flies over the respective sensor stations 104.

According to the example operational protocol 700c shown in FIG. 7C, the ADC system 106 initiates a flight launch at a first predefined drone launch time, using RTC 515, flies over at least one sensor station array 102 according to a defined flight path, collects respective sensor data 202 from respective sensor stations 104 (indicated as “Rx data”), and then returns to land. In some examples, the predefined drone launch time may be synchronized with a predefined time implemented by respective sensor stations 104 for enabling respective BLE transceivers 410, and in some examples may include a predefined delay (e.g., wherein the predefined drone launch time implemented by the ADC system 106 or the predefined time for enabling the BLE transceivers 410 of respective sensor stations 104 is delayed by a predefined period), e.g., as discussed above regarding the example operational protocol 600c.

It should be understood that the various times and time periods (e.g., 10, 12, or 15 minute transmission periods) discussed above, and shown in FIGS. 6A-6D and 7A-7C, are examples only to illustrate example operations of example sensor stations 104 and ADC system 106.

In some examples, the ADC system 106 and/or respective sensor stations 104 may automatically adjust the timing of respective actions over time, for example using a machine learning model. For example, the ADC system 106 and/or respective sensor stations 104 may automatically adjust timing of switching to the periodic wireless communication state (PWCS) by respective sensor stations 104, initiating the transmission of respective sensor data 202 by respective sensor stations 104, or launching a drone flight of the drone-based ADC system 106, without limitation, based on historical data, e.g., data indicating successful or unsuccessful communications of sensor data 202 of respective sensor stations 104 to the ADC system 106.

Although example embodiments have been described above, other variations and embodiments may be made from this disclosure without departing from the spirit and scope of these embodiments.

1. A telemetry system, including:
an array of sensor stations arranged in a spaced apart arrangement;
wherein respective ones of the array of sensor stations comprise:
a respective sensor to generate respective sensor data regarding an object of interest;
a respective sensor station memory to store the respective sensor data;
a respective sensor station antenna;
a respective sensor station wireless transmitter;
a respective sensor station processor to periodically activate the respective sensor station wireless transmitter to transmit the respective sensor data via the respective sensor station antenna;
an aerial data collection system including:
an aerial data collection system antenna; and
an aerial data collection system receiver to receive the respective sensor data transmitted by the respective sensor station antenna.

2. The telemetry system of claim 1, wherein the respective sensor station wireless transmitter comprises a Bluetooth low energy (BLE) transmitter, and the aerial data collection system receiver comprises a BLE receiver.

3. The telemetry system of claim 2, comprising logic instructions executable by the first sensor station processor to encode the first sensor data in BLE advertising packets.

4. The telemetry system of claim 1, wherein the first sensor station antenna comprises a directional antenna arranged to transmit vertically.

5. The telemetry system of claim 1, wherein the aerial data collection system includes:
an aerial data collection system memory; and
an aerial data collection system processor to store, in the aerial data collection system memory, the respective sensor data received by the aerial data collection system receiver.

6. The telemetry system of claim 1, wherein the aerial data collection system is carriable by a drone.

7. The telemetry system of claim 1, wherein respective ones of the array of sensor stations comprise:
a respective sensor station photodetector to detect visible radiation; and
logic instructions executable by the respective sensor station processor to periodically activate the respective sensor station wireless transmitter in response to the radiation detected by the respective sensor station photodetector.

8. The telemetry system of claim 1, wherein:
for respective ones of the array of sensor stations:
the respective sensor station memory stores a respective sensor station identifier associated with the respective sensor station;
the respective sensor station wireless transmitter to transmit the first sensor station identifier with the first sensor data via the first sensor station antenna; and
the aerial data collection system receiver to receive the respective sensor data and associated respective sensor station identifier transmitted by respective ones of the array of sensor stations.

9. The telemetry system of claim 1, wherein the array of sensor stations are arranged at ground level.

10. The telemetry system of claim 1, wherein the first sensor station includes:
logic instructions executable by the first sensor station processor to selectively switch the first sensor station between multiple sensor station operational states including:
a sleep state in which the first sensor and the first sensor station wireless transmitter are deactivated;
a periodic sensing state in which (a) the first sensor is activated to generate the first sensor data, wherein the first sensor data is stored in the first sensor station memory, and (b) the first sensor station wireless transmitter is deactivated; and
a periodic wireless communication state in which the first sensor station wireless transmitter is activated to transmit the first sensor data stored in the first sensor station memory via the first sensor station antenna.

11. The telemetry system of claim 1, wherein:
the array of sensor stations includes:
a first sensor station including a first sensor to generate second sensor data regarding a first object of interest; and
a second station sensor including a second sensor to generate second sensor data regarding a second object of interest; and
the aerial data collection system receiver to receive (a) the first sensor data from the first sensor station and (b) the second sensor data from the second sensor station.

12. A sensor station, including:
a sensor to generate first sensor data regarding a first object of interest;
a memory to store the first sensor data;
an antenna;
a wireless transmitter;
a processor to periodically activate the wireless transmitter to transmit the sensor data via the antenna; and
logic instructions executable by the processor to:
selectively switch the sensor station between multiple sensor station operational states including:
a sleep state in which the sensor and the wireless transmitter are deactivated;
a periodic sensing state in which (a) the sensor is activated to generate the sensor data, wherein the generated sensor data is stored in the memory, and (b) the wireless transmitter is deactivated; and
a periodic wireless communication state in which the wireless transmitter is activated to access and transmit the sensor data stored in the memory via the antenna; and
selectively switch the sensor station to the periodic wireless communication state in response to detecting a presence of a drone-based aerial data collection system.

13. The sensor station of claim 12, including:
a wireless transceiver including the wireless transmitter;
logic instructions executable by the processor to detect the presence of the drone-based aerial data collection system based on signals received at the wireless transceiver from the drone-based aerial data collection system.

14. The sensor station of claim 12, including:
a photodetector to detect radiation; and
logic instructions executable by the processor to periodically activate the wireless transmitter in response to the radiation detected by the photodetector.

15. The sensor station of claim 12, wherein the first sensor station wireless transmitter comprises a Bluetooth low energy (BLE) transmitter, and
the sensor station includes logic instructions executable by the processor to encode the sensor data in BLE advertising packets.

16. The sensor station of claim 12, including:
a wireless receiver to receive and identify a communication from an aerial data collection system; and
logic instructions executable by the processor to activate the wireless transmitter in response to an identification of the communication from the aerial data collection system.

17. A sensor station, including:
a sensor to generate sensor data regarding a sensed entity;
an antenna;
a Bluetooth low energy (BLE) transmitter; and
a processor to:
encode the sensor data in a BLE advertising packet; and
periodically activate the BLE transmitter to transmit the sensor data via the antenna.

18. The sensor station of claim 17, including:
a memory to store the sensor data generated by the sensor; and
logic instructions executable by the processor to selectively switch the sensor station between multiple sensor station operational states including:
a sleep state in which the sensor and the BLE transmitter are deactivated;
a periodic sensing state in which (a) the sensor is activated to generate the sensor data, wherein the generated sensor data is stored in the memory, and (b) the BLE transmitter is deactivated; and
a periodic wireless communication state in which the BLE transmitter is activated to access and transmit the sensor data stored in the memory via the antenna.

19. An aerial data collection system, including:
a navigation system to navigate an aerial device carrying the aerial data collection system along a defined aerial route over an array of sensor stations;
an antenna;
a Bluetooth low energy (BLE) receiver to receive BLE transmissions from the array of sensor stations via the antenna, wherein a respective BLE transmission from a respective sensor station in the array of sensor stations includes respective sensor data encoded in a BLE advertising packet.

20. The aerial data collection system of claim 19, including:
a memory;
a processor; and
logic instructions executable by the processor to identify the respective sensor data encoded in respective BLE advertising packets received by the BLE receiver, and to store the identified respective sensor data in the memory.
